(19) United States
(12) Patent Application Publication
(10) Pub. No.: US 2026/0350872 A1
(43) Pub. Date: Nov. 5, 2026

(54) METHOD, APPARATUS, ELECTRONIC DEVICE AND STORAGE MEDIUM FOR EFFECT GENERATION

(71) Applicant: Beijing Zitiao Network Technology Co., Ltd., Haidian District, Beijing (CN)

(72) Inventors: Bei LI, Beijing (CN); Yuwen QIN, Beijing (CN); Gao LIU, Beijing (CN)

(21) Appl. No.: 19/142,142

(22) PCT Filed: Dec. 13, 2023
(86) PCT No.: PCT/CN2023/138575

§ 371 Date: Jun. 20, 2025

(30) Foreign Application Priority Data
Dec. 23, 2022 (CN) 202211668454.7

(51) Int. Cl. G06T 11/60; G06T 3/60; G06T 13/80; G11B 27/031

(52) U.S. Cl. CPC G06T 11/60; G06T 3/60; G06T 13/80; G06T 2200/24; G11B 27/031

(57) ABSTRACT

A method, apparatus, electronic device and storage medium for effect generation are provided. An effect template is loaded. The effect template includes an effect material placeholder image. The effect template represents an effect style of an effect image based on the effect material placeholder image. Association data of a user is obtained. A corresponding image is generated based on the association data. The association data at least indicates an associated user having an association relationship with the user. The image at least represents identification information of the associated user. The effect material placeholder image is replaced with the image to generate an effect image.

### CROSS-REFERENCE TO RELATED APPLICATION

This application claims priority to Chinese Patent Application No. 202211668454.7, entitled “Method, Apparatus, Electronic Device and Storage Medium for Effect Generation” filed on Dec. 23, 2022, the entire contents of which are incorporated herein by reference.

### FIELD

Embodiments of the present disclosure relate to the field of Internet technologies, and in particular, to a method, apparatus, electronic device and storage medium for effect generation.

### BACKGROUND

In a current video type application (APP), various types of video effect props are usually provided for a user, and the user adds an effect image to the video by using the video effect prop, thereby improving visual expressive force and creation quality of the video.

However, in an actual application process, a video effect provided by a user in the prior art usually requires a user to manually select based on personal preferences, resulting in a problem that a generated video effect has a fixed pattern, lacks an interactive attribute, and the like, and affects a video propagation effect.

### SUMMARY

The embodiments of the present disclosure provides a method, apparatus, electronic device and storage medium for effect generation, and aims to overcome the problems of fixed pattern, lack of interactive attributes and the like of a video effect.

According to a first aspect, an embodiment of the present disclosure provides a method of effect generation, comprising:
loading an effect template, the effect template comprising an effect material placeholder image, the effect template representing an effect style of an effect image based on the effect material placeholder image; obtaining association data of a user, and generating a corresponding image based on the association data, the association data at least indicating an associated user having an association relationship with the user, the image at least representing identification information of the associated user; and replacing the effect material placeholder image with the image to generate an effect image.

According to a second aspect, an embodiment of the present disclosure provides an apparatus for effect generation, comprising:
an obtaining module configured to load an effect template, the effect template comprising an effect material placeholder image, the effect template representing an effect style of an effect image based on the effect material placeholder image;
a processing module configured to obtain association data of a user, and generate a corresponding image based on the association data, the association data at least indicating an associated user having an association relationship with the user, the image at least representing identification information of the associated user;
a generating module configured to replace the effect material placeholder image with the image to generate an effect image.

According to a third aspect, an embodiment of the present disclosure provides an electronic device, comprising:
a processor; and a memory communicatively connected to the processor;
the memory storing computer-executable instructions;
the processor executing the computer-executable instructions stored in the memory to implement the method of effect generation according to the first aspect and various possible designs of the first aspect.

According to a fourth aspect, an embodiment of the present disclosure provides a computer readable storage medium having computer-executable instructions stored thereon, the computer-executable instructions, when executed by a processor, implementing the method of effect generation according to the first aspect and various possible designs of the first aspect.

According to a fifth aspect, an embodiment of the present disclosure provides a computer program product comprising a computer program, the computer program, when executed by a processor, implementing a method of effect generation according to the first aspect and various possible designs of the first aspect.

According to the method, apparatus, electronic device and storage medium for effect generation provided by the embodiment, the effect template is loaded, the effect template comprises an effect material placeholder image, and the effect template represents an effect style of an effect image based on the effect material placeholder image; the association data of the user is obtained, and a corresponding image is generated according to the association data, wherein the association data at least indicates an associated user having an association relationship with the user, the image at least represents identification information of the associated user; and the effect material placeholder image is replaced with the image to generate an effect image. An image of an associated user having an association relationship with the user is generated through the effect template in combination with the association data of the user, and the image is loaded into the effect template, so that the effect image with the interactive attribute is obtained, the effect of generating different effect images for the association relationships of different users is achieved, and the interactive attribute of the video using the effect image is improved.

### BRIEF DESCRIPTION OF DRAWINGS

In order to more clearly illustrate the embodiments of the present disclosure or the technical solutions in the prior art, the accompanying drawings used in the description of the embodiments or the prior art will be briefly introduced below, and it will be apparent that the drawings in the following description are some embodiments of the present disclosure, and those skilled in the art may also obtain other drawings according to these drawings without creative labor.

FIG. 1 is an application scenario diagram of a method of effect generation according to an embodiment of the present disclosure;

FIG. 2 is a schematic flowchart 1 of a method of effect generation according to an embodiment of the present disclosure;

FIG. 3 is a schematic diagram of an effect template according to an embodiment of the present disclosure;

FIG. 4 is an implementation process flow of obtaining association data of a user in step S102;

FIG. 5 is a flowchart of a specific implementation manner of step S1022 in the embodiment shown in FIG. 4;

FIG. 6 is a schematic diagram of a process of generating an image according to an embodiment of the present disclosure;

FIG. 7 is a schematic flowchart 2 of a method of effect generation according to an embodiment of the present disclosure;

FIG. 8 is a flowchart of a specific implementation manner of step S204 in the embodiment shown in FIG. 7;

FIG. 9 is a schematic diagram of an image according to an embodiment of the present disclosure;

FIG. 10 is a flowchart of a specific implementation manner of step S206 in the embodiment shown in FIG. 7;

FIG. 11 is a schematic diagram of a rotated image sequence frame according to an embodiment of the present disclosure;

FIG. 12 is a structural block diagram of an apparatus for effect generation according to an embodiment of the present disclosure;

FIG. 13 is a schematic structural diagram of an electronic device according to an embodiment of the present disclosure;

FIG. 14 is a schematic diagram of a hardware structure of an electronic device according to an embodiment of the present disclosure.

### DETAILED DESCRIPTION

In order to make the objectives, technical solutions and advantages of the embodiments of the present disclosure clearer, the technical solutions in the embodiments of the present disclosure will be clearly and completely described below with reference to the accompanying drawings in the embodiments of the present disclosure. Obviously, the embodiments described herein are merely a part of the embodiments of the present disclosure, rather than all embodiments of the present disclosure. All other embodiments obtained by those skilled in the art based on the embodiments of the present disclosure without creative efforts shall fall within the claimed scope of the present disclosure.

It should be noted that the user information (including but not limited to user equipment information, user personal information, etc.) and data (including but not limited to data for analysis, stored data, presented data, etc.) involved in this application are information and data that are authorized by the user or are sufficiently authorized by the parties, and collection, use and processing of the related data needs to comply with relevant laws and regulations and standards of related countries and areas, and provide a corresponding operation portal for the user to select authorization or decline.

The following describes an application scenario of an embodiment of the present disclosure.

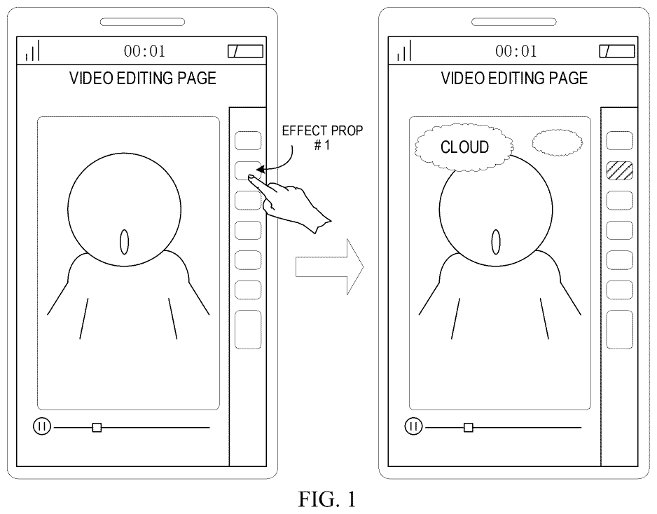

FIG. 1 is an application scenario diagram of a method of effect generation according to an embodiment of the present disclosure. The method of effect generation provided by the embodiments of the present disclosure may be applied to scenarios such as: video editing, video streaming and the like. Specifically, as shown in FIG. 1, the method provided in the embodiments of the present disclosure may be applied to a terminal device or a server, taking a terminal device as an example, the terminal device may be a smart phone, an application client capable of being used for video editing is run in the terminal device, and further, a client of the application includes a video editing page, different effect props are disposed in the video editing page, for example, including the effect prop #1 shown in the figure, and after the user triggers the effect prop by operating the terminal device, an effect image corresponding to the effect prop is added to the video to be edited currently, for example, “cloud” appearing in the video, so that a purpose of adding a virtual item in the video is achieved, a video editing process is completed, and a video content item with a better visual effect is obtained, and the video content item is shared and propagated through a manner of uploading it to a video platform and the like.

In the prior art, the effect props provided by the application client for the user, usually has a fixed style map, which requires the user to manually select based on personal preferences, for example, the “cloud” map selected by the user in FIG. 1. Due to the fact that the style is fixed and monotonous, the effect image generated through the above effect prop cannot cause the resonance of the viewer, so that the generated video content item is caused to lack the interactive attribute, and the video propagation effect is influenced. The embodiment of the present disclosure provides a method of effect generation to solve the problem.

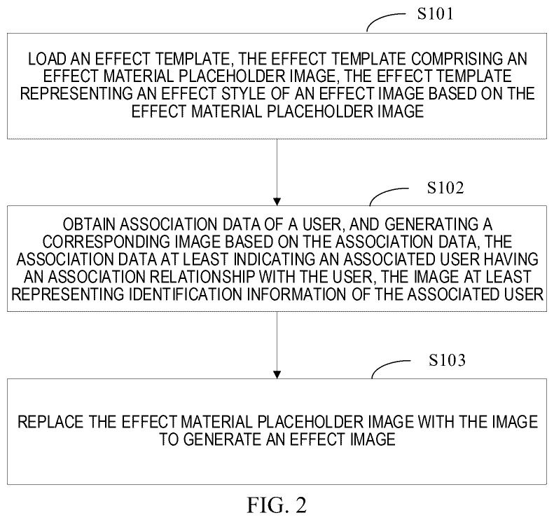

Referring to FIG. 2, FIG. 2 is a schematic flowchart 1 of a method of effect generation according to an embodiment of the present disclosure. The method in this embodiment may be applied to a terminal device or a server. This embodiment takes the terminal device as an execution body for description, the method of effect generation comprises:

Step S101: load an effect template, the effect template comprising an effect material placeholder image, the effect template representing an effect style of an effect image based on the effect material placeholder image.

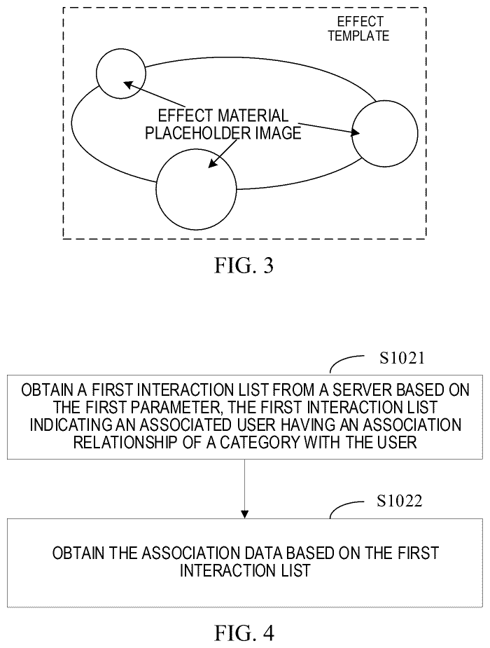

For example, referring to the application scenario schematic diagram shown in FIG. 1, the terminal device present, by running the application client, a video editing interface for video editing to a user, and then obtains, in response to a triggering operation of the user for the effect component in the video editing interface, a corresponding data used to implement the effect style, that is, the effect template. For example, the effect template may include description information corresponding to the effect style and an effect material placeholder image, wherein the effect template generates a corresponding effect image based on the effect material corresponding to the effect material placeholder image. FIG. 3 is a schematic diagram of an effect template according to an embodiment of the present disclosure. As shown in FIG. 3, the content of the effect template is a plurality of “planets” orbiting in a same orbit. The corresponding map of the “planet” is an effect material placeholder image, as the name implies, the effect material placeholder image is used for a placeholder, and in a subsequent step, the effect material placeholder image is replaced with other images, so that dynamic effect material generation is achieved, for example, the effect material placeholder image is replaced with a user profile image, and a visual effect of a plurality of “user profile images” orbiting on the same orbit occurs. As shown in FIG. 3, the above image including 4 “planets” is an effect template. The effect generated by using the effect template is an effect image. The position, the size, the running orbit, and the motion rule of the “planets” in the effect template are collectively referred to as the effect style of the effect image, that is, the effect style of the effect image may be represented by the effect template.

Further, the effect template is pre-generated effect data, which may be pre-stored at the local of the terminal device or server, and the terminal device may obtain various effect templates including the effect template by downloading a client program or accessing a server corresponding to the server end, and the specific implementation manner is not repeated herein.

Step S102: obtain association data of a user, and generating a corresponding image based on the association data, the association data at least indicating an associated user having an association relationship with the user, the image at least representing identification information of the associated user.

For example, after the effect template is loaded, the association data of the user is obtained, wherein the user is the user identity registered based on the virtual platform corresponding to the application, in a possible implementation manner, the login user of the application client running in the terminal device using the method in this embodiment is the user, that is, the user identity of the user of the terminal device. Further, the association data of the user is related data of an associated user having an association relationship with the user in a virtual platform corresponding to the application. The association relationship refers to a virtual relationship constructed based on a platform corresponding to the application. For example, if the user #1 and the user #2 are within a short video platform and are intra-site friends, there is a type of association relationship between the user #1 and the user #2; and the user #3 and the user #4 are within the social platform, and follows each other, so there is another type of association relationship between the user #3 and the user #4. Therefore, by obtaining the association data of the user, the user with some association relationship with the user, that is, the associated user, may be determined, and in short, the associated user of the user may be determined.

More specifically, for example, the association data may be a profile image, a nickname, a signature, or the like of an associated user of the user, and may be set as needed. The association data may be data stored in the server, and on the necessary premise of obtaining the user authorization, the terminal device may obtain the association data based on the indication of the user, and the specific implementation manner is prior art, which is not repeated herein.

In a possible implementation manner, the effect template further comprises a first parameter, and the first parameter represents a category of the association relationship. As shown in FIG. 4, the specific implementation steps of obtaining the association data of the user comprises:

Step S1021: obtain a first interaction list from a server based on the first parameter, the first interaction list indicating an associated user having an association relationship of a category with the user.

Step S1022: obtain the association data based on the first interaction list.

For example, the first interaction list is list information generated based on an interaction behavior between the user and the user, where the first interaction list may be, for example, a “friend list”, a “follow list”, a “like list”, and the like according to a category of the association relationship. For example, the “friend list” corresponds to a bidirectional association relationship, for example, a “follow list” and a “like list” correspond to a unidirectional association relationship, and therefore, taking the first interaction list as a “follow list” as an example, the first interaction list may indicate both associated users followed by the user or associated users following the user.

Further, the first interaction list has a determined mapping relationship with the first parameter, in a possible implementation manner, the first parameter includes, for example, a category identification that represents a category of the association relationship, and a corresponding first interaction list is obtained from the server based on the category identification. Specifically, for example, when the A field in the first parameter is S1, the “friend list” of the user is obtained from the server, and when the A field in the first parameter is S2, the “follow list” of the user is obtained from the server, and when the A field in the first parameter is S3, the “fan list” of the user is obtained from the server.

In this embodiment, the first interaction list is obtained by representing the first parameter of the category of the association relationship, so that the first interaction list corresponds to a specific virtual relationship category, such that an interaction user of a specific category is filtered out, and content control of the effect image is achieved, content flexibility of the effect image is improved, and interactive attributes of the effect image are improved.

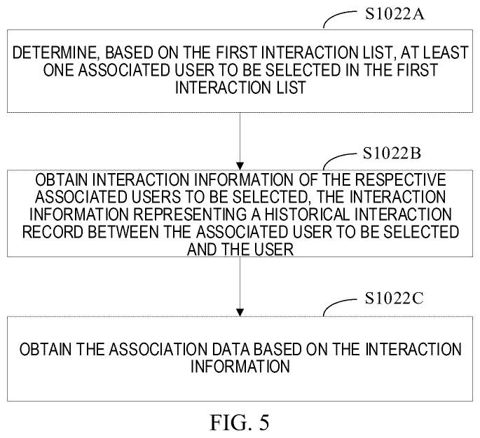

Further, according to the first interaction list obtained from the server, data such as nickname and profile image of the associated user indicated by the first interaction list is obtained, that is, the association data. In a possible implementation manner, the association data may be obtained based on the interaction information between the user and the associated user, where the interaction information represents a historical interaction record between the associated user to be selected in the first interaction list and the user. As shown in FIG. 5, a specific implementation manner of step S1022 includes:

Step S1022A: determine, based on the first interaction list, at least one associated user to be selected in the first interaction list.

Step S1022B: obtain interaction information of the respective associated users to be selected, the interaction information representing a historical interaction record between the associated user to be selected and the user.

Step S1022C: obtain the association data based on the interaction information.

For example, after the first interaction list is determined, when the number of users in the first interaction list is relatively large, the first interaction list may be further filtered to select a few high-quality associated users therein to form the association data. Specifically, the historical interaction record between respective associated users to be selected and the user in the first interaction list is obtained, the historical interaction record includes, for example, the number of messages, the number of likes, the number of interactions and the like between the user and the associated user, the interaction strength of the associated user interacting with the user may be determined through the historical interaction record, and then the association data is determined based on the associated user to be selected with a relatively high interaction strength, where the specific implementation manner may be set as needed, for example, the associated users to be selected whose number of likes in the historical interaction record is greater than the predetermined threshold, or the N (N is a positive integer) associated users to be selected with the highest number of likes are used to form the association data.

In this embodiment, after obtaining the first interaction list of the specific category, the first interaction list is further filtered based on the interaction information, such that the obtained association data and the effect image generated based on the association data have better interactive attributes, and interaction and propagation effects of the video including the effect are improved.

It should be noted that, in another possible implementation manner, the association data of the user may be manually input by the user in advance to the terminal device, for example, the user inputs, to the terminal device, a user nickname, a profile image, and the like used to indicate the associated user. Therefore, the implementation form of obtaining the association data in the foregoing embodiments (steps S1021-S1022) is optionally, needs to be performed on the premise that the user agrees to and obtains the user authorization, and displays prompt information to notify the user before execution.

Further, after obtaining the association data, the association data is converted to generate a corresponding image, the image may be used to present identification information of the associated user, for example, the content of the image includes a profile image, a nickname, and the like of the associated user, such that the user may determine the corresponding associated user through the image. For example, the association data includes a user nickname, in a possible implementation manner, the user nickname in the text form is converted into a corresponding image, and the image font is beautified, for example, adding the color gradient of the font, changing the font type, and the like, to obtain the image. In another possible implementation manner, semantic analysis is performed according to the user nickname to obtain a background image matching the semantics of the user nickname, and then the user nickname and the background image are combined into a complete frame image to obtain the image. The specific implementation manner may be set as required, and details are not described herein again.

Step S103: replace the effect material placeholder image with the image to generate the effect image.

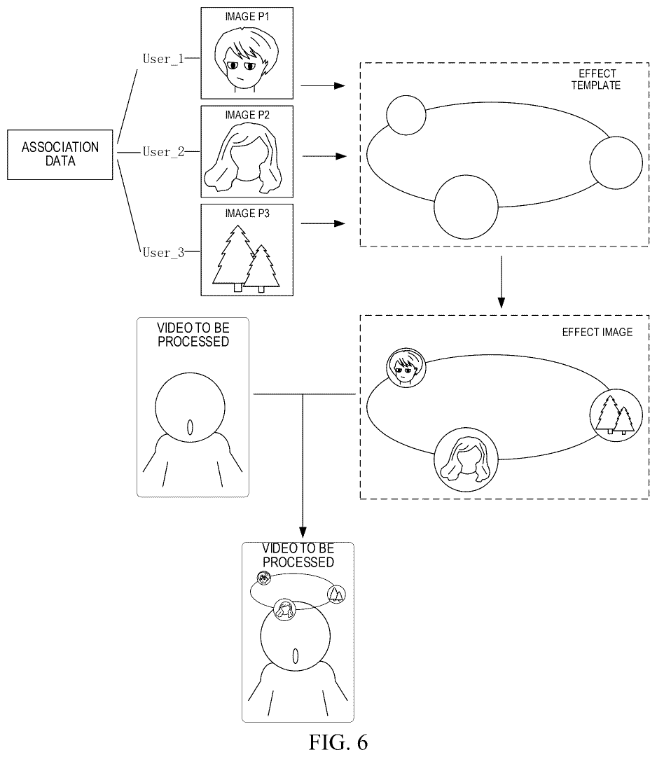

For example, after obtaining the image, the effect material placeholder image in the effect template is replaced with the image, thereby implementing replacement of the effect material in the effect to form a dynamic effect that varies from person to person. Then, the effect image is added to the video to be processed to obtain the image including the interactive attribute effect. FIG. 6 is a schematic diagram of a process of generating an image according to an embodiment of the present disclosure, as shown in FIG. 6, after loading an effect template (specifically described with reference to related description corresponding to FIG. 3), association data of a user is obtained, where the association data includes, for example, a profile image of a friend user (including User_1, User_2, and User_3) of the user, and then processing and converting the associated data to obtain a corresponding image P1, an image P2, and an image P3; and then, replacing the effect material placeholder image in the effect template with the image P1, the image P2, and the image P3 to obtain an effect image, as shown in the figure, the overall effect style of the effect image is not changed relative to the effect template, but the effect material corresponding to the effect material placeholder image therein is replaced, and the image with the interactive attribute is added, such that the generated effect image also has a certain interactive attribute. Then, the effect image is rendered into the video to be processed, and is merged with the video to be processed to obtain the image with the interactive attribute.

In this embodiment, the effect template is loaded, the effect template comprises an effect material placeholder image, and the effect template represents an effect style of an effect image based on the effect material placeholder image; the association data of the user is obtained, and a corresponding image is generated according to the association data, wherein the association data at least indicates an associated user having an association relationship with the user, the image at least represents identification information of the associated user; and the effect material placeholder image is replaced with the image to generate an effect image. An image of an associated user having an association relationship with the user is generated through the effect template in combination with the association data of the user, and the image is loaded into the effect template, so that the effect image with the interactive attribute is obtained, the effect of generating different effect images for the association relationships of different users is achieved, and the interactive attribute of the video using the effect image is improved.

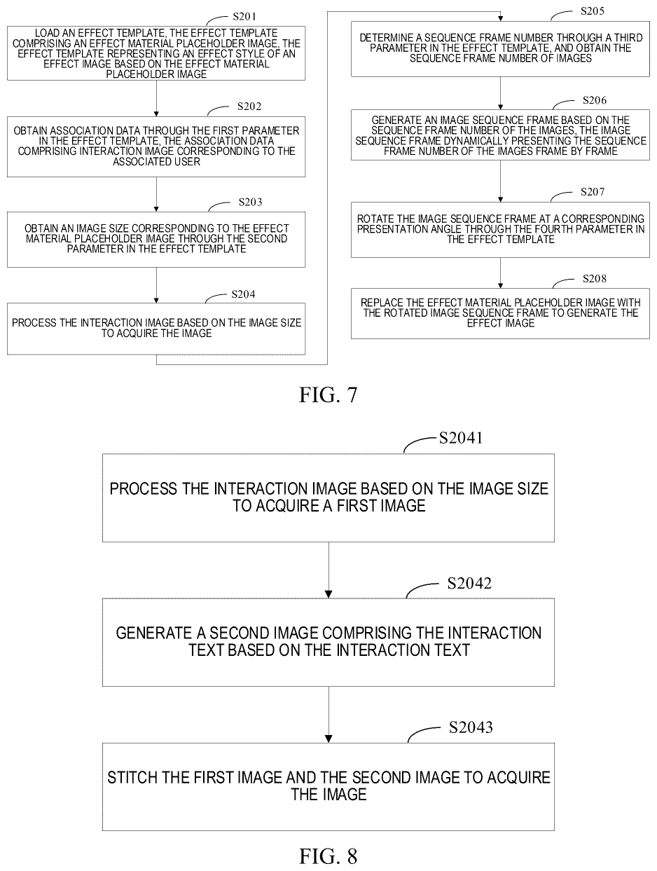

Referring to FIG. 7, FIG. 7 is a schematic flowchart 2 of a method of effect generation according to an embodiment of the present disclosure. On the basis of the embodiment shown in FIG. 2, in this embodiment, step S102 is further refined, and the method of effect generation includes:

Step S201: load an effect template, the effect template comprising an effect material placeholder image, the effect template representing an effect style of an effect image based on the effect material placeholder image.

Step S202: obtain association data through the first parameter in the effect template, the association data comprising interaction image corresponding to the associated user.

For example, in the step S201 and the step S202 in the step of this embodiment, the step that the effect template is loaded, and the first interaction list is obtained according to the first parameter in the effect template, so as to obtain the association data, the specific implementation manner of which is described in detail in the embodiment of FIG. 2, and details are not described herein again. In this embodiment, the association data includes an interaction image corresponding to the associated user, for example, a profile image of the associated user, a home page cover picture of the associated user, and the like.

Step S203: obtain an image size corresponding to the effect material placeholder image through the second parameter in the effect template.

Step S204: process the interaction image based on the image size to acquire the image.

For example, the effect template further includes a second parameter, the second parameter represents image size information corresponding to the effect material placeholder image, and specifically, the second parameter may include parameters such as a picture size and a resolution of the effect material placeholder image. After the second parameter is obtained, size processing is performed on the image to be selected in the association data, for example, the user's profile picture, based on the second parameter, to obtain a picture that meets the picture loading size requirement in the effect template, that is, the picture. In this embodiment, the interaction image is processed through the second parameter, so that the size of the interaction image meets the size requirement of the effect template, the size consistency of the material image in the produced effect image is improved, and the beauty of the effect is improved.

Optionally, the association data further includes an interaction text corresponding to the associated user, as shown in FIG. 8, step S204 includes three specific steps of steps S2041, S2042, and S2043:

Step S2041: process the interaction image based on the image size to acquire a first image.

Step S2042: generate a second image comprising the interaction text based on the interaction text.

Step S2043: stitch the first image and the second image to acquire the image.

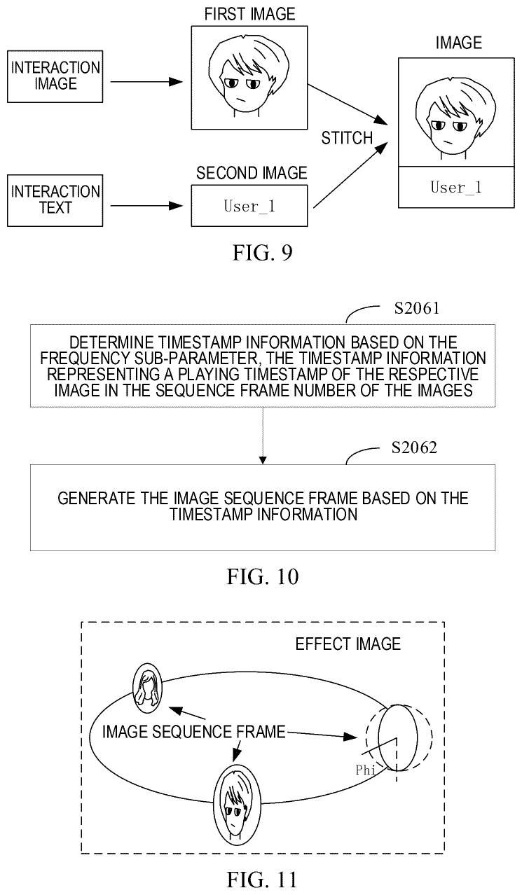

For example, in addition to the interaction image, the association data further includes an interaction text, for example, a user nickname, a user state signature, and the like. For example, for each associated user in the association data, there is a corresponding relationship between the corresponding interaction text and interaction image. After the interaction image is obtained from the association data, the interaction image is first processed based on the first parameter to obtain a first image, and then the interaction text is converted to obtain a corresponding image, that is, the second image. Further, the first image and the second image are stitched to obtain an image. FIG. 9 is a schematic diagram of an image according to an embodiment of the present disclosure. As shown in FIG. 9, the first image is an image generated by a profile image of a certain associated user in the interaction image, the second image is an image generated by a user nick name (Use 1) of a certain associated user in the interaction text, and the images obtained through stitching the above two images is the image.

Step S205: determine a sequence frame number through a third parameter in the effect template, and obtain the sequence frame number of images.

Step S206: generate an image sequence frame based on the sequence frame number of the images, the image sequence frame dynamically presenting the sequence frame number of the images frame by frame.

Further, the effect template further includes a third parameter and a third parameter sequence frame number, and the sequence frame number refers to a number of pictures that form the image sequence frame. The image sequence frame is a dynamic image, that is, a motion image, used to present a plurality of frames of images frame by frame. In a possible implementation manner, the multi-frame image is obtained by using the association data, the sequence frame number of images are selected from the multi-frame image through the third parameter, and merging is performed to generate the image sequence frame, that is, the motion image, for dynamically presenting the sequence frame number of images on a frame-by-frame basis. The implementation method of synthesizing the multi-frame picture into a motion image is the prior art, and details are not described herein again.

Optionally, the third parameter includes a frequency sub-parameter, and the frequency sub-parameter represents a time interval of each image frame in the image sequence frame. As shown in FIG. 10, the step S206 comprises two specific steps: Step S2061 and S2062.

Step S2061: determine timestamp information based on the frequency sub-parameter, the timestamp information representing a playing timestamp of the respective image in the sequence frame number of the images.

Step S2062: generate the image sequence frame based on the timestamp information.

For example, in the process of synthesizing the image sequence frame, the interval between each frame of images is determined by the frequency sub-parameter in the third parameter. The playing timestamp corresponding to respective image may be determined through obtaining the frequency sub-parameter in the third parameter, so as to obtain the playing sequence of the image sequence frame, that is, the timestamp information, and then the image sequence frame is generated based on the timestamp information. In this embodiment, through the frequency sub-parameter in the third parameter, accurate control of the playing rate of the image sequence frame is achieved, the problem that the playing speed of the image sequence frame is too fast or too slow, which affects the presentation effect is avoided, and the effect effectiveness is improved.

Step S207: rotate the image sequence frame at a corresponding presentation angle through the fourth parameter in the effect template.

Step S208: replace the effect material placeholder image with the rotated image sequence frame to generate the effect image.

For example, further, the effect template further includes a fourth parameter, the fourth parameter represents a presentation angle of the effect material placeholder image, where the presentation angle may refer to a presentation angle of the image on a two-dimensional plane where the effect image is located, or may be a presentation angle of a three-dimensional space (camera space) corresponding to the video to be processed which is the extended from the two-dimensional plane. FIG. 11 is a schematic diagram of a rotated image sequence frame according to an embodiment of the present disclosure, as shown in FIG. 11, according to a fourth parameter, an image sequence frame obtained in previous steps is rotated at an angle Phi in a depth-of-field direction, and is in consistent with the presentation angle of the effect material placeholder image, and then a material replacement is performed, an effect material placeholder image is replaced with an image sequence frame, to obtain an effect image with a visual rotation effect. In this embodiment, the visible angle of the image sequence frame is further adjusted through the fourth parameter in the effect template, to acquire a more diversified effect image, thereby improving an effect presentation effect of the effect image.

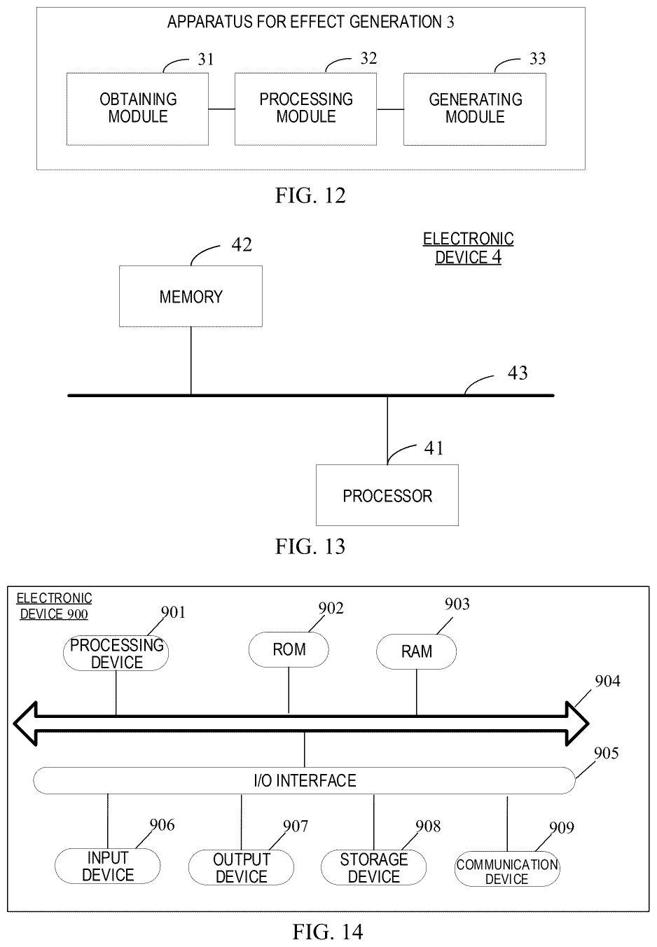

Corresponding to the method of effect generation in the foregoing embodiment, FIG. 12 is a structural block diagram of an apparatus for effect generation according to an embodiment of the present disclosure. For ease of illustration, only portions related to embodiments of the present disclosure are shown. Referring to FIG. 12, the apparatus for effect generation 3 includes:
an obtaining module 31 configured to load an effect template, the effect template comprising an effect material placeholder image, the effect template representing an effect style of an effect image based on the effect material placeholder image.
a processing module 32 configured to obtain association data of a user, and generate a corresponding image based on the association data, the association data at least indicating an associated user having an association relationship with the user, the image at least representing identification information of the associated user.
a generating module 33 configured to replace the effect material placeholder image with the image to generate an effect image.

In an embodiment of the present disclosure, the effect template further comprises a first parameter, the first parameter represents a category of the association relationship; and when obtaining the association data of the user, the processing module 32 is specifically configured to: obtain a first interaction list based on the first parameter, the first interaction list indicating an associated user having an association relationship of a category with the user; and obtain the association data based on the first interaction list.

In an embodiment of the present disclosure, when obtaining the association data based on the first interaction list, the processing module 32 is specifically configured to: determine, based on the first interaction list, at least one associated user to be selected in the first interaction list; obtain interaction information of the respective associated user to be selected, the interaction information representing a historical interaction record between the associated user to be selected and the user; and obtain the association data based on the interaction information.

In an embodiment of the present disclosure, the association data comprises an interaction image corresponding to the associated user, the effect template further comprises a second parameter, the second parameter represents image size information corresponding to the effect material placeholder image; and when generating a corresponding image based on the association data, the processing module 32 is specifically configured to: obtain an image size corresponding to the effect material placeholder image through the second parameter; and process the interaction image based on the image size to acquire the image.

In an embodiment of the present disclosure, the association data further comprises interaction text corresponding to the associated user; when processing the interaction image based on the image size to acquire the image, the processing module 32 is specifically configured to: process the interaction image based on the image size to acquire a first image; generate a second image comprising the interaction text based on the interaction text; and stitch the first image and the second image to acquire the image.

In an embodiment of the present disclosure, the effect template further comprises a third parameter, the third parameter represents a sequence frame number; before replacing the effect material placeholder image with the image to generate the effect image, the generating module 33 is further configured to: obtain the sequence frame number of images; generate an image sequence frame based on the sequence frame number of the images, the image sequence frame dynamically presenting the sequence frame number of the images frame by frame; and the generating module 33 is specifically configured to replace the effect material placeholder image with the image sequence frame to generate the effect image.

In an embodiment of the present disclosure, the third parameter comprises a frequency sub-parameter, the frequency sub-parameter represents a time interval of each image frame in the image sequence frame; when generating the image sequence frame based on the sequence frame number of the images, the generating module 33 is specifically configured to: determine timestamp information based on the frequency sub-parameter, the timestamp information representing a playing timestamp of the respective image in the sequence frame number of the images; and generate the image sequence frame based on the timestamp information.

In an embodiment of the present disclosure, the effect template further comprises a fourth parameter, the fourth parameter represents a presentation angle of the effect material placeholder image; and the generating module 33 is specifically configured to: rotate the image at a corresponding presentation angle based on the fourth parameter, and replace the effect material placeholder image with the rotated image to generate the effect image.

The obtaining module 31, the processing module 32, and the generating module 33 are connected in sequence. The apparatus for effect generation 3 provided in this embodiment may perform the technical solutions of the foregoing method embodiments, and implementation principles and technical effects thereof are similar, and details are not described herein again in this embodiment.

FIG. 13 is a schematic structural diagram of an electronic device according to an embodiment of the present disclosure. As shown in FIG. 13, the electronic device 4 comprises:
a processor 41, and a memory 42 communicatively connected to the processor 41;
the memory 42 stores computer executable instructions;
the processor 41 executes the computer-executable instructions stored in the memory 42 to implement the method of effect generation in the embodiments shown in FIG. 2 to FIG. 11.

Optionally, the processor 41 and the memory 42 are connected by using a bus 43.

Related descriptions may be understood with reference to related descriptions and effects corresponding to the steps in the embodiments corresponding to FIG. 2 to FIG. 11, and details are not described herein again.

An embodiment of the present disclosure provides a computer-readable storage medium, where the computer-readable storage medium stores computer-executable instructions, and when the computer-executable instructions are executed by a processor, the computer-executable instructions are configured to implement the method of effect generation provided in any one of the embodiments corresponding to FIG. 2 to FIG. 11 of this application.

FIG. 14 shows a schematic structural diagram of an electronic device 900 suitable for implementing embodiments of the present disclosure, and the electronic device 900 may be a terminal device or a server. The terminal device may include, but is not limited to, a mobile terminal such as a mobile phone, a notebook computer, a digital broadcast receiver, a personal digital assistant (PDA), a tablet computer (PAD), a portable multimedia player (PMP), an in-vehicle terminal (for example, an in-vehicle navigation terminal), and a fixed terminal such as a digital TV, a desktop computer, or the like. The electronic device shown in FIG. 14 is merely an example, and should not impose any limitation on the functions and scope of use of the embodiments of the present disclosure.

As shown in FIG. 14, the electronic device 900 may include a processing device (for example, a central processing unit, a graphics processor, etc.) 901, which may perform various appropriate actions and processing according to a program stored in a read only memory (ROM) 902 or a program loaded into a random access memory (RAM) 903 from a storage device 908. In the RAM 903, various programs and data required by the operation of the electronic device 900 are also stored. The processing device 901, the ROM 902, and the RAM 903 are connected to each other through a bus 904. Input/output (I/O) interface 905 is also connected to bus 904.

Generally, the following devices may be connected to the I/O interface 905: an input device 906 including, for example, a touch screen, a touch pad, a keyboard, a mouse, a camera, a microphone, an accelerometer, a gyroscope, etc. ; an output device 907 including, for example, a liquid crystal display (LCD), a speaker, a vibrator, etc., a storage device 908 including, for example, a magnetic tape, a hard disk, etc.; and a communication device 909. The communication device 909 may allow the electronic device 900 to communicate wirelessly or wired with other devices to exchange data. While FIG. 14 shows an electronic device 900 having various devices, it should be understood that it is not required to implement or have all illustrated devices. More or fewer devices may alternatively be implemented or provided.

In particular, according to an embodiment of the present disclosure, the process described above with reference to the flowchart may be implemented as a computer software program. For example, embodiments of the present disclosure include a computer program product comprising a computer program embodied on a computer readable medium, the computer program comprising program code for performing the method shown in the flowchart. In such embodiments, the computer program may be downloaded and installed from the network through the communication device 909, or installed from the storage device 908, or from the ROM 902. When the computer program is executed by the processing device 901, the foregoing functions defined in the method of the embodiments of the present disclosure are performed.

It should be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, device, or device, or any combination thereof. More specific examples of computer-readable storage media may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted with any suitable medium, including, but not limited to: wires, optical cables, RF (radio frequency), and the like, or any suitable combination of the foregoing.

The computer-readable medium described above may be included in the electronic device; or may be separately present without being assembled into the electronic device.

The computer-readable medium carries one or more programs, and when the one or more programs are executed by the electronic device, the electronic device is enabled to perform the method shown in the foregoing embodiments.

Computer program code for performing the operations of the present disclosure may be written in one or more programming languages, including object oriented programming languages, such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (for example, using an Internet service provider for Internet connection).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. The naming of the unit does not construct any limitation of the unit itself in certain situation. For example, the first obtaining unit may be further described as “obtaining at least two units of Internet Protocol addresses”.

The functions described above may be performed, at least in part, by one or more hardware logic components. For example, without limitation, illustrative types of hardware logic components that may be used include: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

According to a first aspect, a method of effect generation is provided according to one or more embodiments of the present disclosure, comprising:
loading an effect template, the effect template comprising an effect material placeholder image, the effect template representing an effect style of an effect image based on the effect material placeholder image; obtaining association data of a user, and generating a corresponding image based on the association data, the association data at least indicating an associated user having an association relationship with the user, the image at least representing identification information of the associated user; and replacing the effect material placeholder image with the image to generate an effect image.

According to one or more embodiments of the present disclosure, the effect template further comprises a first parameter, the first parameter represents a category of the association relationship; obtaining the association data of the user comprises: obtaining a first interaction list based on the first parameter, the first interaction list indicating an associated user having an association relationship of a category with the user; and obtaining the association data based on the first interaction list.

According to one or more embodiments of the present disclosure, obtaining the association data based on the first interaction list comprises: determining, based on the first interaction list, at least one associated user to be selected in the first interaction list; obtaining interaction information of the respective associated user to be selected, the interaction information representing a historical interaction record between the associated user to be selected and the user; and obtaining the association data based on the interaction information.

According to one or more embodiments of the present disclosure, the association data comprises an interaction image corresponding to the associated user, the effect template further comprises a second parameter, the second parameter represents image size information corresponding to the effect material placeholder image; generating a corresponding image based on the association data comprises: obtaining an image size corresponding to the effect material placeholder image through the second parameter; and processing the interaction image based on the image size to acquire the image.

According to one or more embodiments of the present disclosure, the association data further comprises interaction text corresponding to the associated user; processing the interaction image based on the image size to acquire the image comprises: processing the interaction image based on the image size to acquire a first image; generating a second image comprising the interaction text based on the interaction text; and stitching the first image and the second image to acquire the image.

According to one or more embodiments of the present disclosure, the effect template further comprises a third parameter, the third parameter represents a sequence frame number; before replacing the effect material placeholder image with the image to generate the effect image, further comprising: obtaining the sequence frame number of images; generating an image sequence frame based on the sequence frame number of the images, the image sequence frame dynamically presenting the sequence frame number of the images frame by frame; replacing the effect material placeholder image with the image to generate the effect image comprises: replacing the effect material placeholder image with the image sequence frame to generate the effect image.

According to one or more embodiments of the present disclosure, the third parameter comprises a frequency sub-parameter, the frequency sub-parameter represents a time interval of each image frame in the image sequence frame; generating the image sequence frame based on the sequence frame number of the images comprises: determining timestamp information based on the frequency sub-parameter, the timestamp information representing a playing timestamp of the respective image in the sequence frame number of the images; and generating the image sequence frame based on the timestamp information.

According to one or more embodiments of the present disclosure, the effect template further comprises a fourth parameter, the fourth parameter represents a presentation angle of the effect material placeholder image; replacing the effect material placeholder image with the image to generate the effect image comprises: rotating the image at a corresponding presentation angle based on the fourth parameter, and replacing the effect material placeholder image with the rotated image to generate the effect image.

According to a second aspect, an apparatus for effect generation is provided according to one or more embodiments of the present disclosure, comprising:
an obtaining module configured to load an effect template, the effect template comprising an effect material placeholder image, the effect template representing an effect style of an effect image based on the effect material placeholder image.
a processing module configured to obtain association data of a user, and generate a corresponding image based on the association data, the association data at least indicating an associated user having an association relationship with the user, the image at least representing identification information of the associated user.
a generating module configured to replace the effect material placeholder image with the image to generate an effect image.

In an embodiment of the present disclosure, the effect template further comprises a first parameter, the first parameter represents a category of the association relationship; when obtaining the association data of the user, the processing module is specifically configured to: obtain a first interaction list based on the first parameter, the first interaction list indicating an associated user having an association relationship of a category with the user; and obtain the association data based on the first interaction list.

In an embodiment of the present disclosure, when obtaining the association data based on the first interaction list, the processing module is specifically configured to: determine, based on the first interaction list, at least one associated user to be selected in the first interaction list; obtain interaction information of the respective associated user to be selected, the interaction information representing a historical interaction record between the associated user to be selected and the user; and obtain the association data based on the interaction information.

In an embodiment of the present disclosure, the association data comprises an interaction image corresponding to the associated user, the effect template further comprises a second parameter, the second parameter represents image size information corresponding to the effect material placeholder image; and when generating a corresponding image based on the association data, the processing module is specifically configured to: obtain an image size corresponding to the effect material placeholder image through the second parameter; and process the interaction image based on the image size to acquire the image.

In an embodiment of the present disclosure, the association data further comprises interaction text corresponding to the associated user; when processing the interaction image based on the image size to acquire the image, the processing module is specifically configured to: process the interaction image based on the image size to acquire a first image; generate a second image comprising the interaction text based on the interaction text; and stitch the first image and the second image to acquire the image.

In an embodiment of the present disclosure, the effect template further comprises a third parameter, the third parameter represents a sequence frame number; before replacing the effect material placeholder image with the image to generate the effect image, the generating module is further configured to: obtain the sequence frame number of images; generate an image sequence frame based on the sequence frame number of the images, the image sequence frame dynamically presenting the sequence frame number of the images frame by frame; and the generating module is specifically configured to replace the effect material placeholder image with the image sequence frame to generate the effect image.

In an embodiment of the present disclosure, the third parameter comprises a frequency sub-parameter, the frequency sub-parameter represents a time interval of each image frame in the image sequence frame; and when generating the image sequence frame based on the sequence frame number of the images, the generating module is specifically configured to: determine timestamp information based on the frequency sub-parameter, the timestamp information representing a playing timestamp of the respective image in the sequence frame number of the images; and generate the image sequence frame based on the timestamp information.

In an embodiment of the present disclosure, the effect template further comprises a fourth parameter, the fourth parameter represents a presentation angle of the effect material placeholder image; and the generating module is specifically configured to: rotate the image at a corresponding presentation angle based on the fourth parameter, and replacing the effect material placeholder image with the rotated image to generate the effect image.

According to a third aspect, an electronic device is provided according to one or more embodiments of the present disclosure, comprising: a processor, and a memory communicatively connected to the processor;
the memory storing computer executable instructions;
the processor executes the computer-executable instructions stored in the memory, to implement the method of effect generation according to the first aspect and various possible designs of the first aspect.

According to a fourth aspect, a computer-readable storage medium is provided according to one or more embodiments of the present disclosure, where the computer-readable storage medium stores computer-executable instructions, and when the processor executes the computer-executable instructions, the method of effect generation according to the first aspect and the possible designs of the first aspect is implemented.

According to a fifth aspect, an embodiment of the present disclosure provides a computer program product, including a computer program, where the computer program, when executed by a processor, implements the method of effect generation according to the first aspect and various possible designs of the first aspect.

The above description is merely an illustration of the preferred embodiments of the present disclosure and the principles of the application. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept. For example, the above features are the technical solutions formed by mutually replacing technical features disclosed in the present disclosure (but not limited to).

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely illustrative forms of implementing the claims.

1. A method of effect generation, comprising:
loading an effect template, the effect template comprising an effect material placeholder image, the effect template representing an effect style of an effect image based on the effect material placeholder image;
obtaining association data of a user, and generating a corresponding image based on the association data, the association data at least indicating an associated user having an association relationship with the user, the image at least representing identification information of the associated user;
replacing the effect material placeholder image with the image to generate an effect image.

2. The method of claim 1, wherein the effect template further comprises a first parameter, the first parameter represents a category of the association relationship;
obtaining the association data of the user comprises:
obtaining a first interaction list based on the first parameter, the first interaction list indicating an associated user having an association relationship of a category with the user; and
obtaining the association data based on the first interaction list.

3. The method of claim 2, wherein obtaining the association data based on the first interaction list comprises:
determining, based on the first interaction list, at least one associated user to be selected in the first interaction list;
obtaining interaction information of the respective associated user to be selected, the interaction information representing a historical interaction record between the associated user to be selected and the user; and
obtaining the association data based on the interaction information.

4. The method of claim 1, wherein the association data comprises an interaction image corresponding to the associated user, the effect template further comprises a second parameter, the second parameter represents image size information corresponding to the effect material placeholder image;
generating a corresponding image based on the association data comprises:
obtaining an image size corresponding to the effect material placeholder image through the second parameter; and
processing the interaction image based on the image size to acquire the image.

5. The method of claim 4, wherein the association data further comprises interaction text corresponding to the associated user;
processing the interaction image based on the image size to acquire the image comprises:
processing the interaction image based on the image size to acquire a first image;
generating a second image comprising the interaction text based on the interaction text; and
stitching the first image and the second image to acquire the image.

6. The method of claim 1, wherein the effect template further comprises a third parameter, the third parameter represents a sequence frame number;
before replacing the effect material placeholder image with the image to generate the effect image, further comprising:
obtaining the sequence frame number of images;
generating an image sequence frame based on the sequence frame number of the images, the image sequence frame dynamically presenting the sequence frame number of the images frame by frame;
replacing the effect material placeholder image with the image to generate the effect image comprises:
replacing the effect material placeholder image with the image sequence frame to generate the effect image.

7. The method of claim 6, wherein the third parameter comprises a frequency sub-parameter, the frequency sub-parameter represents a time interval of each image frame in the image sequence frame;
generating the image sequence frame based on the sequence frame number of the images comprises:
determining timestamp information based on the frequency sub-parameter, the timestamp information representing a playing timestamp of the respective image in the sequence frame number of the images; and
generating the image sequence frame based on the timestamp information.

8. The method of claim 1, wherein the effect template further comprises a fourth parameter, the fourth parameter represents a presentation angle of the effect material placeholder image;
replacing the effect material placeholder image with the image to generate the effect image comprises:
rotating the image at a corresponding presentation angle based on the fourth parameter, and replacing the effect material placeholder image with the rotated image to generate the effect image.

9. (canceled)

10. An electronic device, comprising: a processor; and a memory communicatively connected to the processor;
the memory storing computer-executable instructions;
the processor executing the computer-executable instructions stored in the memory to implement a method of effect generation comprising:
loading an effect template, the effect template comprising an effect material placeholder image, the effect template representing an effect style of an effect image based on the effect material placeholder image;
obtaining association data of a user, and generating a corresponding image based on the association data, the association data at least indicating an associated user having an association relationship with the user, the image at least representing identification information of the associated user;
replacing the effect material placeholder image with the image to generate an effect image.

11-19. (canceled)

20. The electronic device of claim 10, wherein the effect template further comprises a first parameter, the first parameter represents a category of the association relationship;
obtaining the association data of the user comprises:
obtaining a first interaction list based on the first parameter, the first interaction list indicating an associated user having an association relationship of a category with the user; and
obtaining the association data based on the first interaction list.

21. The electronic device of claim 20, wherein obtaining the association data based on the first interaction list comprises:
determining, based on the first interaction list, at least one associated user to be selected in the first interaction list;
obtaining interaction information of the respective associated user to be selected, the interaction information representing a historical interaction record between the associated user to be selected and the user; and
obtaining the association data based on the interaction information.

22. The electronic device of claim 10, wherein the association data comprises an interaction image corresponding to the associated user, the effect template further comprises a second parameter, the second parameter represents image size information corresponding to the effect material placeholder image;
generating a corresponding image based on the association data comprises:
obtaining an image size corresponding to the effect material placeholder image through the second parameter; and
processing the interaction image based on the image size to acquire the image.

23. The electronic device of claim 22, wherein the association data further comprises interaction text corresponding to the associated user;
processing the interaction image based on the image size to acquire the image comprises:
processing the interaction image based on the image size to acquire a first image;
generating a second image comprising the interaction text based on the interaction text;
and stitching the first image and the second image to acquire the image.

24. The electronic device of claim 10, wherein the effect template further comprises a third parameter, the third parameter represents a sequence frame number;
before replacing the effect material placeholder image with the image to generate the effect image, further comprising:
obtaining the sequence frame number of images;
generating an image sequence frame based on the sequence frame number of the images, the image sequence frame dynamically presenting the sequence frame number of the images frame by frame;
replacing the effect material placeholder image with the image to generate the effect image comprises:
replacing the effect material placeholder image with the image sequence frame to generate the effect image.

25. The electronic device of claim 24, wherein the third parameter comprises a frequency sub-parameter, the frequency sub-parameter represents a time interval of each image frame in the image sequence frame;
generating the image sequence frame based on the sequence frame number of the images comprises:
determining timestamp information based on the frequency sub-parameter, the timestamp information representing a playing timestamp of the respective image in the sequence frame number of the images; and
generating the image sequence frame based on the timestamp information.

26. The electronic device of claim 10, wherein the effect template further comprises a fourth parameter, the fourth parameter represents a presentation angle of the effect material placeholder image;
replacing the effect material placeholder image with the image to generate the effect image comprises:
rotating the image at a corresponding presentation angle based on the fourth parameter, and replacing the effect material placeholder image with the rotated image to generate the effect image.

27. A non-transitory computer-readable storage medium having computer-executable instructions stored thereon, the computer-executable instructions, when executed by a processor, implementing a method of effect generation comprising:
loading an effect template, the effect template comprising an effect material placeholder image, the effect template representing an effect style of an effect image based on the effect material placeholder image;
obtaining association data of a user, and generating a corresponding image based on the association data, the association data at least indicating an associated user having an association relationship with the user, the image at least representing identification information of the associated user;
replacing the effect material placeholder image with the image to generate an effect image.

28. The non-transitory computer-readable storage medium of claim 27, wherein the effect template further comprises a first parameter, the first parameter represents a category of the association relationship;
obtaining the association data of the user comprises:
obtaining a first interaction list based on the first parameter, the first interaction list indicating an associated user having an association relationship of a category with the user; and
obtaining the association data based on the first interaction list.

29. The non-transitory computer-readable storage medium of claim 28, wherein obtaining the association data based on the first interaction list comprises:
determining, based on the first interaction list, at least one associated user to be selected in the first interaction list;
obtaining interaction information of the respective associated user to be selected, the interaction information representing a historical interaction record between the associated user to be selected and the user; and
obtaining the association data based on the interaction information.

30. The non-transitory computer-readable storage medium of claim 27, wherein the association data comprises an interaction image corresponding to the associated user, the effect template further comprises a second parameter, the second parameter represents image size information corresponding to the effect material placeholder image;
generating a corresponding image based on the association data comprises:
obtaining an image size corresponding to the effect material placeholder image through the second parameter; and
processing the interaction image based on the image size to acquire the image.
